(19) United States
(12) Patent Application Publication
(10) Pub. No.: US 2009/0207277 A1
(43) Pub. Date: Aug. 20, 2009

(54) VIDEO CAMERA AND TIME-LAG CORRECTION METHOD

(75) Inventors: Junji Kurihara, Hino-shi (JP); Kenichi Ishii, Ome-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/372,466

(22) Filed: Feb. 17, 2009

(30) Foreign Application Priority Data
Feb. 20, 2008 (JP) 2008-039124

(51) Int. Cl. H04N 5/04; H04N 5/76; H04N 5/225; H04N 5/917

(52) U.S. Cl. 348/231.4; 348/500; 348/231.4; 348/135; 348/384.1; 348/E05.009

(57) ABSTRACT

According to one embodiment, a video camera comprises an imaging module configured to pick up a moving image of a subject and output a video signal, a microphone configured to pick up sound and output an audio signal, and a synchronization module configured to correct a time lag between the audio signal and video signal according to a distance of the subject.

### CROSS-REFERENCE TO RELATED APPLICATIONS

This application is based upon and claims the benefit of priority from Japanese Patent Application No. 2008-039124, filed Feb. 20, 2008, the entire contents of which are incorporated herein by reference.

### BACKGROUND

1. Field

One embodiment of the invention relates to a video camera that corrects a time lag between the video and the audio, and relates to a time-lag correction method for the video camera.

2. Description of the Related Art

Generally, a video camera has a zoom function and is thereby capable of varying the focal distance of a lens. If a focal distance is lengthened, even a subject in the far distance can be picked up at high magnification, thus appearing as if it was located in the near distance. However, even if the focal distance is changed, sound recorded through a microphone with single directionality is still played back in a conventional way, resulting in a non-synchronism between the playback of video and audio. To overcome this problem, devices for recording a sound field control code (e.g., Jpn. Pat. Appln. KOKAI Publication No. 2-62171) have been proposed. This device is designed such that where a focal distance is short, a sound field control code for playing back the sound field as if the sound were emitted from a nearer distance is recorded. When the focal distance is long, a sound field control code for playing back the sound field as if the sound were emitted from a farther distance is recorded. When played back, one of the sound field control codes is transmitted to a sound field varying device simultaneously with a read audio signal, thus making it possible to control the sound field assigned for recording sound.

In the device disclosed in this patent document, a sound field control code matching a video is recorded on a video tape simultaneously with a video signal, and transfers the sound field control code to the read sound field varying device, thereby making it possible to play back sound with a sound field matching the video.

However, the device described in this document could not eliminate a time lag between the audio and video due to the difference between the velocities of sound and light. In the case of zoom photography, especially, in the case of lengthening a focal distance in order to pick up a subject in the far distance, such as fireworks, the moment of a baseball's being hit as seen from a spectator's seat, or a vehicle running in a motor race, the timing of the sound recording is significantly delayed compared to the timing of the video recording. This may result in an audio delay during playback such that a viewer of the resultant video feels discomfort.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram of an example of the electrical configuration of a video camera according to one embodiment of the present invention;

FIG. 2 is an exemplary block diagram of another example of the electrical configuration of the video camera according to the one embodiment;

FIG. 3A shows an example of a distance meter in FIG. 2 in detail;

FIG. 3B shows another example of the distance meter in FIG. 2 in detail;

FIG. 4A is an exemplary perspective view showing the appearance of the video camera according to the one embodiment;

FIG. 4B is another exemplary perspective view showing the appearance of the video camera according to the one embodiment;

FIG. 5 is an exemplary diagram of the composition of a program stream in the video camera according to the one embodiment;

FIG. 6A shows an example of a PES packet in FIG. 5 in detail;

FIG. 6B shows another example of the PES packet in FIG. 5 in detail;

FIG. 7 shows an example of a video and audio synchronizing module in the video camera according to the one embodiment;

FIG. 8 shows another example of a video and audio synchronizing module in the video camera according to the one embodiment;

FIG. 9 shows yet another example of a video and audio synchronizing module in the video camera according to the one embodiment; and

FIG. 10 is an exemplary diagram of the playback process of a program stream picked up and recorded by a video camera according to one embodiment.

### DETAILED DESCRIPTION

Various embodiments according to the invention will be described hereinafter with reference to the accompanying drawings. In general, according to one embodiment of the invention, a video camera comprises an imaging module configured to pick up a moving image of a subject and output a video signal; a microphone configured to pick up sound and output an audio signal; and a synchronization module configured to correct a time lag between the audio signal and video signal according to a distance of the subject.

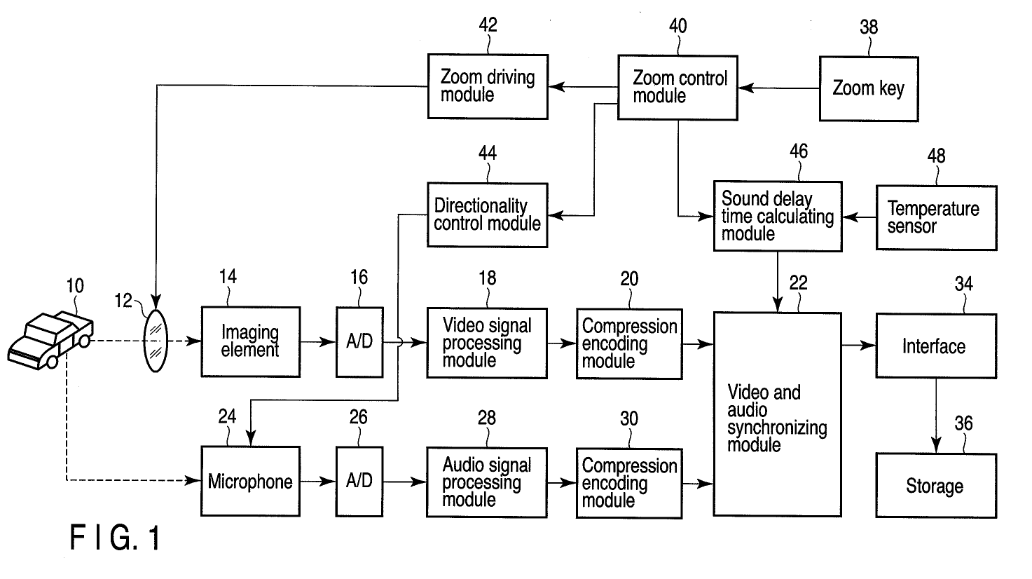

According to an embodiment, FIG. 1 shows an example a digital video camera that digitizes video and audio signals and records the video and audio signals in a memory card (e.g., a semiconductor memory), a hard disk device, an optical disk, etc. However, the present invention is also applicable in an analog video camera that uses video tapes or such like as recording media.

FIG. 1 is an exemplary block diagram of the electric circuit of the video camera. An image of a subject acquired through a zoom lens 12 is formed on the light receiving face of an imaging element 14, e.g., a CCD (Charge Coupled Device) sensor or MOS (Metal Oxide Semiconductor) sensor, and then converted into an analog video signal (i.e., a moving image), which is an electric signal based on comparative brightness of light. The analog video signal output from the imaging element 14 is converted into a digital signal by an analog-digital (A/D) converting module 16, and is output to a video signal processing module 18.

In the video signal processing module 18, the digital video signal is subjected to processes such as gamma correction, color signal separation, or white balance adjustment, and then supplied to a compression encoding module 20. Following a predetermined compression encoding system such as MPEG-4 (Moving Picture Experts Group), the compression encoding module 20 compresses and encodes a video signal output from the video signal processing module 18, and supplies the encoded video data to a video and audio synchronizing module 22.

Meanwhile, an analog audio signal corresponding to the sounds of the surroundings is picked up by a microphone 24 and converted into a digital signal by an analog-digital (A/D) converting module 26, and then input to an audio signal processing module 28.

In the audio signal processing module 28, the digital audio signal is subjected to processes such as noise removal, and supplied to a compression encoding module 30. Following a predetermined compression encoding system such as MPEG-4 (Moving Picture Experts Group), as in the video signal, the compression encoding module 30 compresses and encodes the audio signal output from the audio signal processing module 28, and then inputs this signal to the video and audio signal processing module 22.

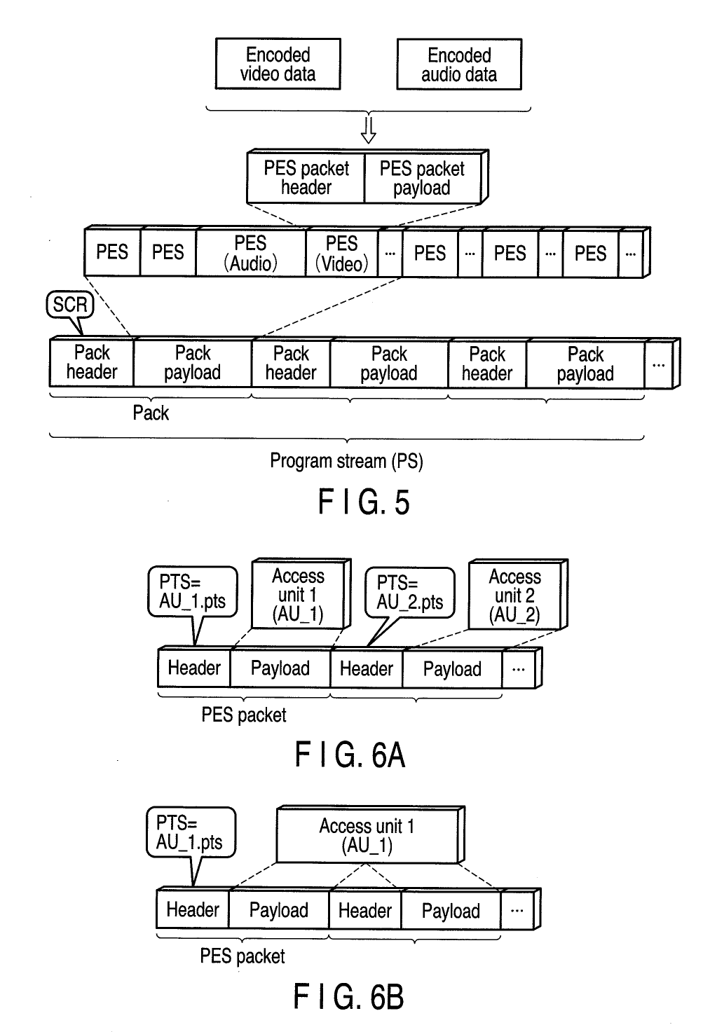

As shown in FIG. 5, the video and audio synchronizing module 22 multiplexes the encoded video data and encoded audio data in synchronization with each other, thereby creating a program stream in the MPEG-4 system, and outputs this stream to the interface 34.

As shown in FIG. 5, the program stream is formed from a plurality of packs, each of which includes a pack header and a pack payload. The pack header stores reference clock information that is called system clock references (SCR). The pack payload includes a group of PES (packetized Elementary Stream) packets. Each of the PES packets includes a PES packet header and a PES packet payload. Each PES packet payload has, as a predetermined unit, encoded video data or encoded audio data.

Each PES packet header stores the display time PTS (Presentation Time Stamp) of an access unit, which is the unit for decoding and playing back. If one access unit is composed of one PES packet, the head of the PES packet stores PTSs, as shown in FIG. 6A. If one access unit is composed of a plurality of PES packets, the header of the PES packet that includes the first byte of the access unit stores the PTS, as shown in FIG. 6B.

Such a program stream is stored in a storage 36 via an interface 34. The interface 34 performs modulation, error correction blocking, etc. A digital storage medium such as a hard disk, DVD, or semiconductor memory, can be used as the storage 36.

The focal distance of the zoom lens 12 is variable, and the focus is electrically operated by a zoom driving module 42 that includes a motor, etc. A zoom control signal from a zoom key 38 that inputs a control signal for focusing is input to a zoom control module 40.

The directionality of the microphone 25 can be changed for example, in two steps (i.e., non-directionality for near distance and sharp directionality for far distance). In order to change the directionality according to the zooming operation of the lens 12, the zoom control module 40 controls the directionality of the microphone 25 via a directionality control module 44. The directionality of the microphone 25 may simply be fixed so as to match the direction of the optical axis of the lens 12.

As described in the problems to be solved by the invention, the time taken for the optical image of a subject 10 to reach the video camera and the time taken for sound emitted from this subject 10 to reach the video camera are not exactly the same due to the difference between sound and light velocities. In particular, where a subject in the far distance is zoomed in and picked up, the sound delay is long. This may result in a time lag between the image and sound when an image zoomed in and picked up at high magnification is played back. In the present embodiment, according to the distance of a subject, the video and audio synchronizing module 22 calculates the difference between the times taken for the optical image of the subject and for the sound to reach the video camera; and controls the synchronization of the video and audio so that the time lag between the video and sound is compensated to take into account the calculated time difference.

In the example shown in FIG. 1, the zoom control module 40 supplies a sound delay time calculating module 46 with a zoom control signal (i.e., a zoom in signal for lengthening the focal distance or zoom out signal for shortening it) transmitted from the zoom key 38. The result of the calculation is supplied to the video and audio synchronizing module 22. Generally, when a subject in the far distance is picked up, the video camera zooms in to increase the magnification of the image. When a subject in the near distance is picked up, the video camera zooms out so that the subject is within a frame. It is accordingly understood that the position of the zoom lens 12 is in proportion to the distance of the subject.

The sound delay time calculating module 46 calculates the time required for sound emitted from a subject to reach the microphone 24, and sets this time as the delay time of the audio corresponding to the video. The delay time can be found by dividing the distance of the subject by the sound velocity. Incidentally, since the sound velocity may vary according to atmospheric temperature, the delay time can be obtained more accurately by providing a temperature sensor 48 and correcting the sound velocity from the following equation according to atmospheric temperature:

Sound velocity=331.5+0.61t,
where t is the atmospheric temperature.

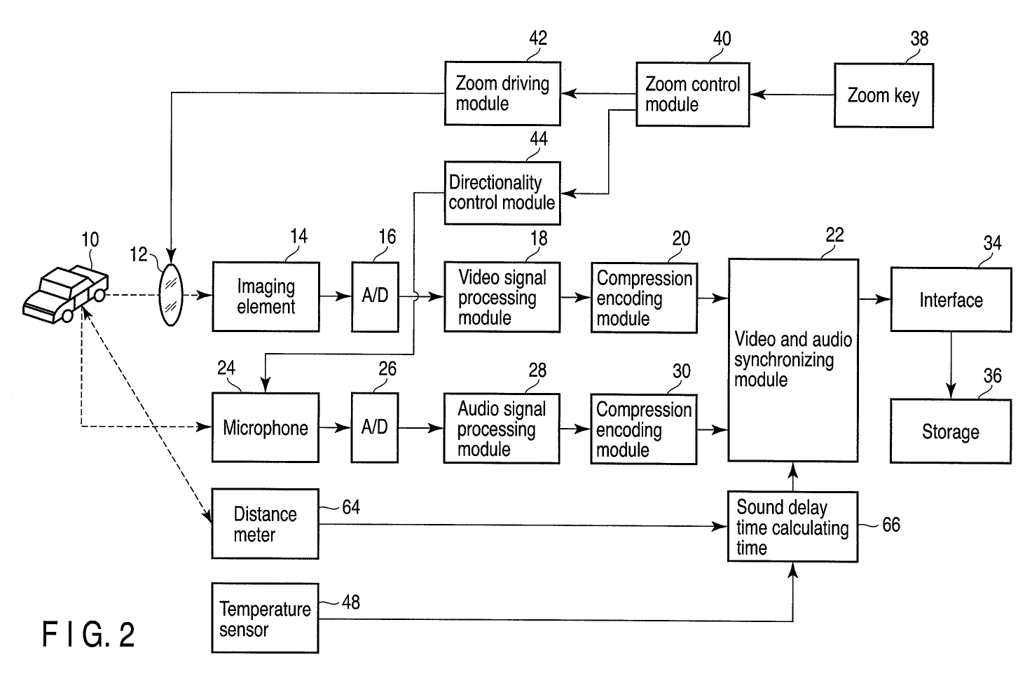

FIG. 2 is a block diagram showing another example of the electric circuit in the video camera. The configuration shown in FIG. 2 is identical to that in FIG. 1, except that a distance meter 64 for measuring the actual distance of the subject 10 and a temperature sensor 48 are provided, the outputs of the distance meter 64 and the temperature sensor 48 are supplied to the sound delay time calculating module 66, and the result of the calculation is supplied to the video and audio synchronizing module 22.

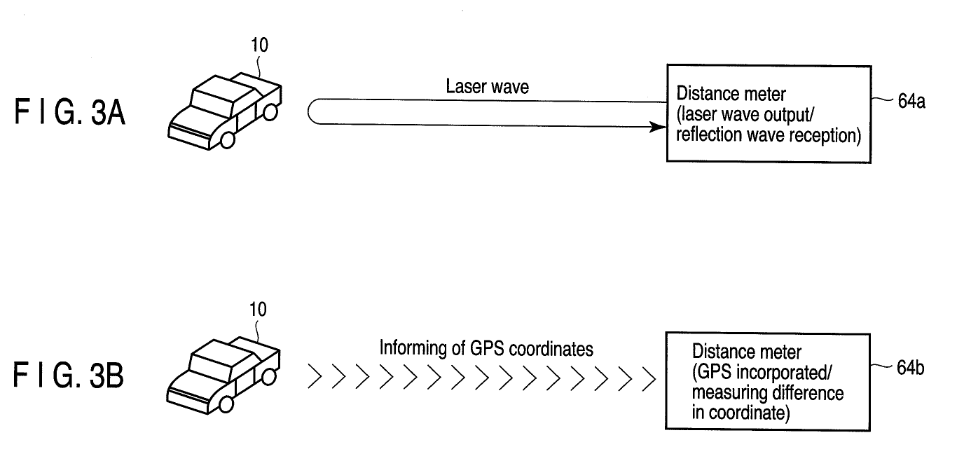

The distance meter 64 may be a distance meter 64a, as shown in FIG. 3A, which outputs a laser wave toward the subject 10, receives the wave reflected from the subject 10, and calculates the distance from the time taken for this. Alternatively, the distance member 64 may be a distance meter 64b, as shown in FIG. 3B, which involves GPS (Global Positioning System) sensors incorporated in the subject 10 and in the video camera, and which receives a position detection signal (i.e., coordinates) transmitted from the GPS sensor in the subject 10, and calculates the distance from the difference between these coordinates and the coordinates detected by the GPS sensor in the video camera.

The sound delay time calculating module 66 calculates the delay time by dividing the distance obtained by the distance meter 64 by the sound velocity. In the example shown in FIG. 2 as well, the sound velocity is corrected according to the atmospheric temperature detected by the temperature sensor 48.

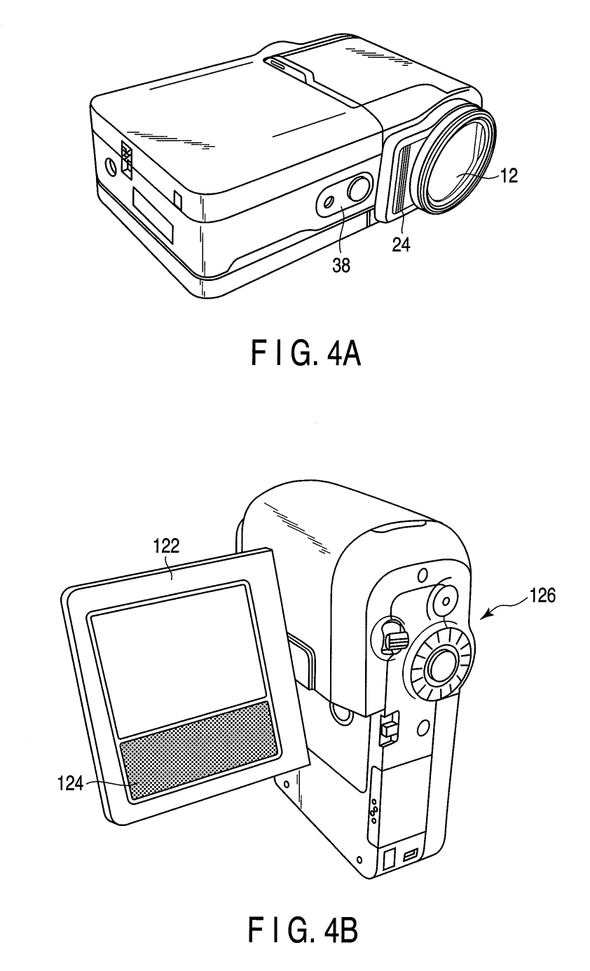

FIGS. 4A and 4B are perspective views schematically showing a camera body. As shown in FIG. 4A, the zoom lens 12 is disposed on the front of the camera body. Disposed below the zoom lens 12 is the microphone 24. Below the microphone 24 is the zoom key 38 on which index and middle fingers rest. The temperature sensor 48 (not shown for ease of view) is disposed between the microphone 24 and zoom lens 12.

Image capture is carried out with the video camera held in a vertical position, as shown in FIG. 4B. The camera body is provided with a monitor display 122 that may be freely opened or closed relative to the camera body and freely rotated around the opening or closing axis. A loudspeaker 124 is disposed below the screen of the monitor display 122. On the rear face of the camera body is an operating module 126 capable of transmitting (i.e., inputting) control signals to the main control module (not shown) so as to correspond to operations performed by a user. Representative examples of control signals would be the selection of an operating mode, the selection of an image and a mode during playback/editing, or the turning on/off of video recording.

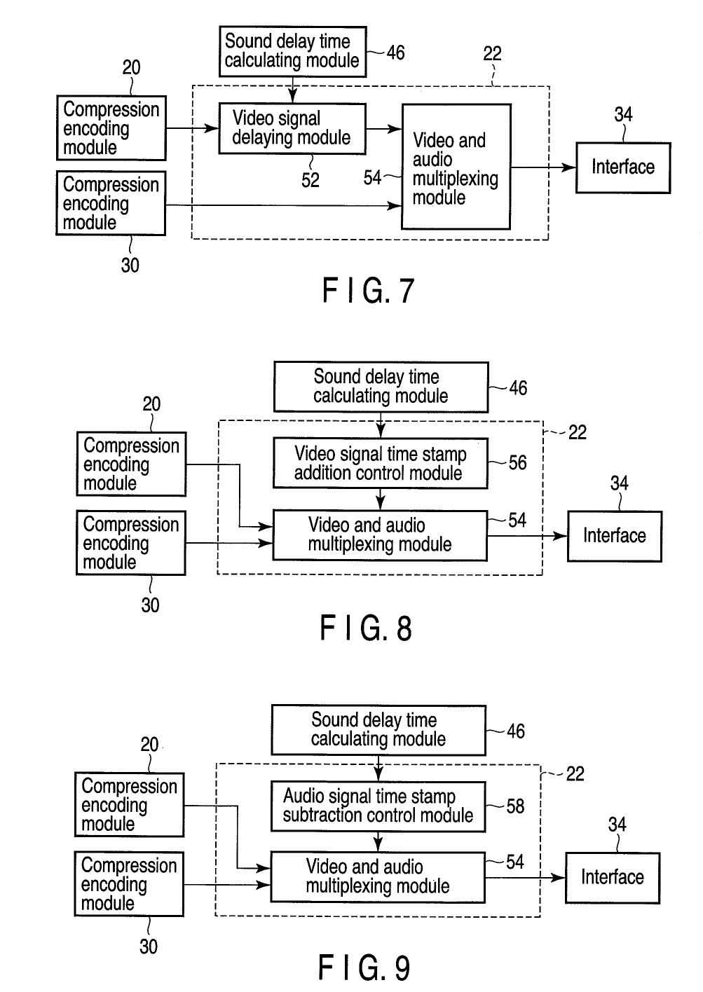

An example of the video audio synchronizing module 22 shown in FIGS. 1 and 2 will be described in detail below, referring to FIGS. 7 to 9.

In the example shown in FIG. 7, the encoded video data from the compression encoding module 20 is supplied to a video and audio multiplexing module 54 via a video signal delaying module 52. The video signal delaying module 52 supplies the encoded video data to the video and audio multiplexing module 54 after delaying the encoded video data by the delay time (corresponding to the video signal) of the audio signal, which has been calculated by the audio signal delay calculating module 46. This prevents a time lag between the video and audio signals when the encoded video data is input to the video and audio multiplexing module 54 and, accordingly, both signals synchronize with each other. As shown in FIG. 6, the video and audio multiplexing module 54 writes display time information (PTS) on the header of the PES packet composed of the encoded video or audio data, multiplexes this information into one stream and outputs this. Where the video packet and the audio packet are input to the video and audio multiplexing module 54 simultaneously, equal PTS values are written. For example, where the access units 1 and 2, shown in FIG. 6A, are a video packet and an audio packet respectively, and are input to the video and audio multiplexing module 54 simultaneously, the PTS in the header of the access unit 1 and that in the access unit 2 are equal.

On the other hand, FIGS. 8 and 9 show examples where different PTS values according to the delay time of the sound are written on the video packet and audio packet input to the video and audio multiplexing module 54 simultaneously. Since the playback timing is determined by each PTS, rewriting the PTS makes it possible to substantially delay the video signal in relation to the audio packet input to the video and audio synchronizing module 54 simultaneously with the video packet.

In the example in FIG. 8, encoded video data and encoded audio data from the compression encoding modules 20 and 30 respectively are supplied to the video and audio synchronizing module 54 as they are. The output of the audio signal delay calculating module 46 is supplied to a video signal time stamp addition control module 56, and when video and audio synchronizing module 54 multiplexes the encoded video data and encoded audio data input simultaneously, the time stamp of the video signal is adjusted. That is, the display time of the PES packet is determined by the time stamp (PTS: display time) included in the packet header. Therefore, the PTSs of the video packets output from the compression encoding modules 20 and 30 with the same timing are increased according to the delay time calculated by the delay time calculating module 46, and the time to play back the video packet can be thereby delayed. This substantially delays the video packet. Consequently, the video packet is delayed and played back in synchronization with the audio packet input to the multiplexing module 54.

In the example shown in FIG. 9, encoded video data and encoded audio data from the compression encoding modules 20 and 30 respectively are supplied to the video and audio synchronizing module 54 as they are. The output of the audio signal delay calculating module 46 is supplied to an audio signal time stamp subtraction control module 58, by which the time stamp of the audio signal is adjusted when the video and audio multiplexing module 54 multiplexes the encoded video data and encoded audio data that are input simultaneously. That is, the PTS of the audio packet output from the compression encoding modules 20 and 30 with the same timing as the PTS of the video packet is decreased according to the delay time calculated by the delay time calculating module 46, thereby providing time to play back the audio packet earlier. This substantially delays the video packet. Consequently, the audio packet is played back in synchronization with the video packet input to the multiplexing module 54 earlier than the video packet.

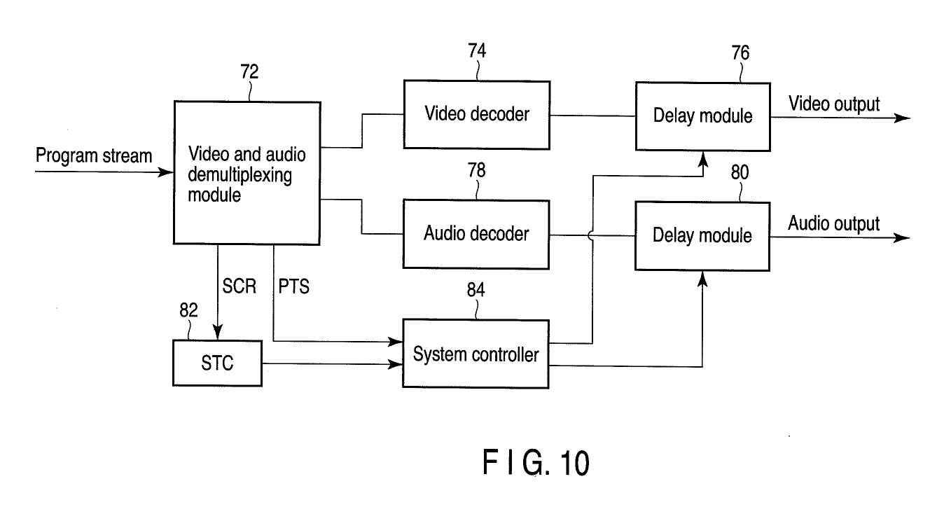

Although not shown in FIG. 1, a playback module for playing back a stream stored in the storage 36 is also incorporated in the video camera. FIG. 10 is a block diagram of the electric configuration of the playback module.

A program stream read from the storage 36 is supplied to a video and audio demultiplexing module 72, and separated into a video packet and an audio packet. The video and audio packets are supplied as a video output and audio output respectively via video decoder 74 and audio decoder 78 respectively and further via delay modules 76 and 80 respectively. The video output is supplied to the display 122, and the audio output, to a loudspeaker (not shown).

A reference value SCR stored in the pack header is supplied to a system time counter (STC) 82, and a reference clock incorporating count values obtained by counting the SCRs is supplied to the system controller 84. The display time PTS read from the head of each packet is also supplied to the system controller. The system controller 84 controls the delay times of the delay modules 76 and 80 so that when both times coincide, the packets are played back (i.e., displayed).

As described above, the first embodiment eliminates a time lag between the video and audio during playback of a video tape and ensures more realistic sensations at zooming-in, by delaying the video or making the audio earlier according to the sound delay time in relation to the video, which delay time is determined according to the distance of the subject.

According to the invention, a time lag between the audio signal and the video signal can be corrected according to the distance of a subject. This eliminates the time-lag between the video and audio even where the image is zoomed in, thus enabling zoom photography which ensures that sensations are realistic.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The various modules of the systems described herein can be implemented as software applications, hardware and/or software modules, or components on one or more computers, such as servers. While the various modules are illustrated separately, they may share some or all of the same underlying logic or code. The accompanying claims and their equivalents are intended to cover such forms or modifications as would fall within the scope and spirit of the inventions.

For example, the present invention is applicable in an analog video camera that uses video tape. However, in this case, time stamps are not recorded, and the time-lag correction is accordingly limited to the example, as shown in FIG. 7, in which a delay circuit synchronizes the video and audio before information is recorded on a recording medium. The examples of the program streams and the examples of the distance meter 64, which were described above in detail, are not limited to these only but may be modified as necessity requires. The microphone 25 may not be able to change its directionality. Additionally, the temperature sensor 48 may not be available and, therefore, sound velocity correction according to temperature may be omitted.

What is claimed is:

1. A video camera comprising:
an imaging module configured to capture a moving image of an object and to output a video signal;
a microphone configured to record sound and to output an audio signal; and
a synchronization module configured to correct a time lag between the audio signal and the video signal according to a distance of the object.

2. The video camera of claim 1, wherein the synchronization module is configured to adjust an amount of correction according to a zoom factor of a zoom lens in the imaging module.

3. The video camera of claim 1, further comprising a distance measuring module configured to measure the distance of the object, and
wherein the synchronization module is configured to adjust an amount of correction according to the distance measured by the distance measuring module.

4. The video camera of claim 2, further comprising an atmospheric temperature measuring module, and
wherein the synchronization module is configured to adjust the amount of correction in accordance with the atmospheric temperature measured by the atmospheric temperature measuring module.

5. The video camera of claim 3, further comprising an atmospheric temperature measuring module, and
wherein the synchronization module is configured to adjust the amount of correction, further according to the atmospheric temperature measured by the atmospheric temperature measuring module.

6. The video camera of claim 1, wherein the synchronization module is configured to delay the video signal according to the distance of the object.

7. The video camera of claim 1, further comprising a compressor configured to creating an MPEG program stream from the video signal and the audio signal, and
wherein the program stream comprises packs, each pack comprising a pack header and a pack payload, the pack header configured to store reference clock information, the pack payload comprising packets, each packet comprising a packet header and a packet payload, the packet header configured to store a display time for an access unit for decoding and playing back; and
the synchronization module is configured to add a predetermined time to the display time stored in the packet header corresponding to the video signal.

8. The video camera of claim 1, further comprising a compressor configured to create an MPEG program stream from the video signal and the audio signal, and
wherein the program stream comprises packs, each pack comprising a pack header and a pack payload, the pack header configured to store reference clock information, the pack payload comprising packets, each packet comprising a packet header and a packet payload, the packet header configured to store a display time for an access unit for decoding and playing back; and
the synchronization module is configured to subtract a predetermined time from the display time stored in the packet header corresponding to the video signal.

9. A time-lag correction method comprising:
detecting a distance of an object; and
correcting a time lag between an audio signal and a video signal according to the detected distance.

10. The time-lag correction method of claim 9, wherein the correcting further comprises:
delaying the video signal according to the detected distance; and
synchronizing a delayed video signal and the audio signal.

11. The time-lag correction method of claim 9, wherein the correcting comprises adding a time difference to time information assigned to the video signal and the audio signal according to the detected distance.

12. The time-lag correction method of claim 9, further comprising measuring a temperature,
wherein the correcting comprises correcting the time lag according to the detected distance and a measured temperature.
